(19) United States
(12) Patent Application Publication
(10) Pub. No.: US 2026/0021849 A1
(43) Pub. Date: Jan. 22, 2026

(54) VEHICLE SIDE STRUCTURE

(71) Applicant: TOYOTA JIDOSHA KABUSHIKI KAISHA, Toyota-shi (JP)

(72) Inventor: Susumu Takenaka, Toyota-shi (JP)

(73) Assignee: TOYOTA JIDOSHA KABUSHIKI KAISHA, Toyota-shi (JP)

(21) Appl. No.: 19/239,034

(22) Filed: Jun. 16, 2025

(30) Foreign Application Priority Data
Jul. 17, 2024 (JP) 2024-114347

(51) Int. Cl. B62D 25/04

(52) U.S. Cl. CPC B62D 25/04

(57) ABSTRACT

A vehicle side structure includes a pillar outer member formed in a substantially L-shape by a front wall and an outer wall as viewed in section in a vehicle up-down direction and constituting a pillar, and a door frame member provided so as to extend in the vehicle front-rear direction inside the side door and having a rear end overlapping the pillar outer member as viewed from a side in a vehicle width direction, and a bead portion extending in the vehicle width direction is formed in a predetermined region including a portion at the same height position as the rear end of the door skeleton member on the front wall of the pillar outer member in a side view viewed from the vehicle width direction.

### CROSS-REFERENCE TO RELATED APPLICATION

This application claims priority to Japanese Patent Application No. 2024-114347 filed on Jul. 17, 2024. The disclosure of the above-identified application, including the specification, drawings, and claims, is incorporated by reference herein in its entirety.

### BACKGROUND

### 1. Technical Field

The present disclosure relates to vehicle side structures.

### 2. Description of Related Art

There is conventionally known a pillar reinforcing structure of an automobile that can reduce both bending deformation in the event of a vehicle side-impact collision and buckling deformation in the event of a vehicle frontal collision without causing an increase in vehicle body weight and an increase in cost (see, for example, Japanese Unexamined Patent Application Publication No. 2014-069632 (JP 2014-069632 A)). A recessed bead extending in an up-down direction across a door beltline is formed in a pillar reinforcement of the pillar reinforcing structure.

### SUMMARY

In case of a side-impact collision of a vehicle, an inward load in a vehicle width direction may be applied from a door impact beam provided inside a side door to a pillar. In this case, large inward buckling deformation in the vehicle width direction occurs in the pillar near a portion to which the load is applied.

It is therefore an object of the present disclosure to provide a vehicle side structure that can reduce deformation of a pillar even when an inward load in a vehicle width direction is applied from a door frame member provided inside a side door to the pillar in the event of a side-impact collision of a vehicle.

In order to achieve the above object, a vehicle side structure according to a first aspect of the present disclosure includes:
a pillar outer member that constitutes a pillar, the pillar outer member having a substantially L-shape made by a front wall and an outer wall as viewed in section in a vehicle up-down direction; and
a door frame member provided inside a side door so as to extend in a vehicle front-rear direction, a rear end of the door frame member overlapping the pillar outer member as viewed from a side in a vehicle width direction.

A bead portion extending in the vehicle width direction is provided in a predetermined region including a portion of the front wall of the pillar outer member. The portion of the front wall is a portion located at the same height position as the rear end of the door frame member as viewed from the side in the vehicle width direction.

In the first aspect of the present disclosure, the door frame member extending in the vehicle front-rear direction is provided inside the side door. The pillar outer member constitutes the pillar, and has a substantially L-shape made by the front wall and the outer wall as viewed in section in the vehicle up-down direction. The rear end of the door frame member overlaps the pillar outer member as viewed from the side in the vehicle width direction. The “vehicle front-rear direction” that is a direction in which the door frame member extends includes a “substantial vehicle front-rear direction” that is slightly tilted downward from the front side of a vehicle toward the rear side of the vehicle, as viewed from the side in the vehicle width direction.

The bead portion extending in the vehicle width direction is provided in the predetermined region including a portion of the front wall of the pillar outer member. The portion of the front wall is a portion located at the same height position as the rear end of the door frame member as viewed from the side in the vehicle width direction. This configuration improves stiffness of the front wall of the pillar outer member against an inward load in the vehicle width direction compared to a case where the bead portion extending in the vehicle width direction is not provided in the front wall of the pillar outer member. Accordingly, even when an inward load in the vehicle width direction is applied from the door frame member to the pillar in the event of a side-impact collision of the vehicle, deformation of the pillar due to this load is reduced.

According to a second aspect of the present disclosure, in the vehicle side structure according to the first aspect, the bead portion may be provided in the front wall except for both ends in the vehicle width direction of the front wall.

In the second aspect of the present disclosure, the bead portion is provided in the front wall of the pillar outer member except for both ends in the vehicle width direction of the front wall. This configuration further improves the stiffness of the front wall of the pillar outer member against an inward load in the vehicle width direction compared to a case where the bead portion is provided in the front wall of the pillar outer member including both ends in the vehicle width direction of the front wall. Accordingly, even when an inward load in the vehicle width direction is applied from the door frame member to the pillar in the event of a side-impact collision of the vehicle, deformation of the pillar due to this load is more effectively reduced.

According to a third aspect of the present disclosure, in the vehicle side structure according to the first or second aspect, the predetermined region may be a region within 100 mm upward and downward in the vehicle up-down direction from the rear end of the door frame member.

In the third aspect of the present disclosure, the predetermined region is a region within 100 mm upward and downward in the vehicle up-down direction from the rear end of the door frame member. This configuration more effectively ensures the stiffness of the pillar outer member compared to a case where, for example, the predetermined region is a region within 200 mm upward in the vehicle up-down direction from the rear end of the door frame member. Specifically, this configuration more effectively ensures the stiffness of the front wall of the pillar outer member against an inward load in the vehicle width direction that is applied from the rear end of the door frame member. Accordingly, even when an inward load in the vehicle width direction is applied from the door frame member to the pillar in the event of a side-impact collision of the vehicle, deformation of the pillar due to this load is more effectively reduced.

According to a fourth aspect of the present disclosure, in the vehicle side structure according to any one of the first to third aspects, the bead portion may be a recessed portion recessed toward a rear of a vehicle.

In the fourth aspect of the present disclosure, the bead portion is a recessed portion recessed toward the rear of the vehicle. This configuration does not affect opening and closing of the side door and eliminates the need to change the design of the shape of the side door, compared to the case where the bead portion is a protruding portion protruding toward the front of the vehicle.

As described above, the present disclosure can reduce deformation of a pillar even when an inward load in the vehicle width direction is applied from a door frame member provided inside a side door to the pillar in the event of a side-impact collision of a vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic perspective view showing a vehicle side structure according to the present embodiment;

FIG. 2 is a schematic perspective view showing an enlarged recessed portion formed in the pillar outer panel constituting the vehicle side structure according to the present embodiment;

FIG. 3 is a schematic side view showing a vehicle side structure according to the present embodiment;

FIG. 4 is a schematic plan sectional view showing a vehicle side structure according to the present embodiment;

FIG. 5A is a schematic planar sectional view of the vehicle side structure according to the embodiment at the time of a side-impact collision;

FIG. 5B is a schematic planar sectional view of the vehicle side structure according to the embodiment after a side-impact collision; and

FIG. 6 is a schematic plan view of the vehicle side structure according to the embodiment after a side-impact collision.

### DETAILED DESCRIPTION OF EMBODIMENTS

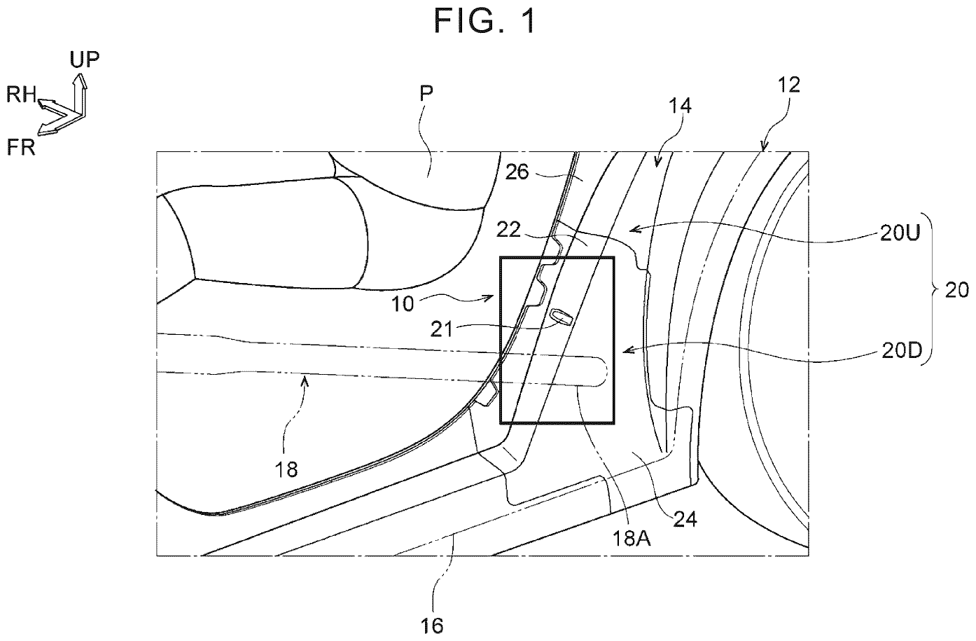

Hereinafter, an embodiment according to the present disclosure will be described in detail with reference to the drawings. For convenience of description, the arrow UP, the arrow FR, and the arrow RH appropriately shown in the figures indicate the upward direction of a vehicle, the forward direction of the vehicle, and the right direction of the vehicle, respectively. When terms indicating directions, i.e., upward and downward, forward and rearward, and right and left are used in the following description without any specification, these mean upward and downward of the vehicle, forward and rearward of the vehicle, and right and left of the vehicle. Further, the left-right direction is synonymous with a vehicle width direction. Further, the dummy doll for the collision test shown in FIGS. 1, 3, and 6 is referred to as an occupant P.

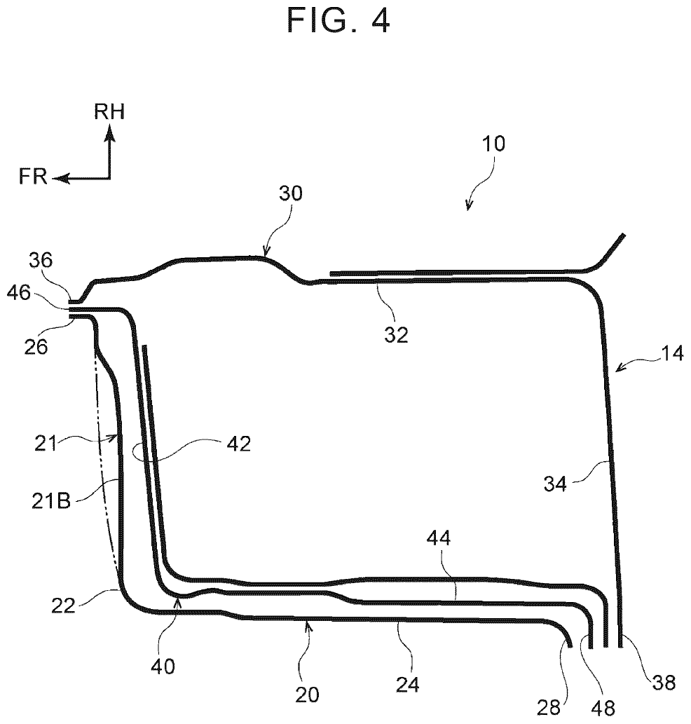

As shown in FIGS. 1, 3, and 4, a rear pillar 14 as an example of a pillar of the vehicle 12 including the vehicle side structure 10 includes a pillar outer panel 20 and a pillar inner panel 30. The pillar outer panel 20 is a pillar outer member extending in the up-down direction. The pillar inner panel 30 extends in the up-down direction and forms a closed sectional shape with the pillar outer panel 20. A pillar reinforcement 40 is provided inside the pillar outer panel 20 (see FIG. 4).

The pillar outer panel 20 extends in the up-down direction by integrally joining the panel upper 20U and the panel lower portion 20D so as to be continuous. In addition, the pillar outer panel 20 is formed in a substantially L-shape by the front wall 22 and the outer wall 24 as viewed in section in the up-down direction (hereinafter referred to as “as viewed in planar section”). As shown in FIG. 4, the pillar inner panel 30 is formed in a substantially inverted L-shape by the inner wall 32 and the rear wall 34 as viewed in planar section, and the pillar reinforcement 40 is formed in a substantially L-shape by the front wall 42 and the outer wall 44 as viewed in planar section.

A front flange portion 26 extending in the up-down direction and extending forward as viewed in planar section is integrally formed at an inner end of the front wall 22 of the pillar outer panel 20 in the vehicle width direction. At a rear end of the outer wall 24 of the pillar outer panel 20, a rear flange portion 28 extending in the up-down direction and extending outward in the vehicle width direction as viewed in planar section is integrally formed.

A front flange portion 36 is integrally formed at a front end of the inner wall 32 of the pillar inner panel 30. The front flange portion 36 extends in the up-down direction and extends forward as viewed in planar section. A rear flange portion 38 is integrally formed at an outer end of the rear wall 34 of the pillar inner panel 30 in the vehicle width direction. The rear flange portion 38 extends in the up-down direction and extends outward in the vehicle width direction as viewed in planar section.

A front flange portion 46 is integrally formed at an inner end of the front wall 42 of the pillar reinforcement 40 in the vehicle width direction. The front flange portion 46 extends in the up-down direction and extends forward as viewed in planar section. A rear flange portion 48 is integrally formed at a rear end of the outer wall 44 of the pillar reinforcement 40. The rear flange portion 48 extends in the up-down direction and extends outward in the vehicle width direction as viewed in planar section.

Therefore, the front flange portion 36 of the pillar inner panel 30 is overlapped and welded to the front flange portion 26 of the pillar outer panel 20 via the front flange portion 46 of the pillar reinforcement 40. The rear flange portion 38 of the pillar inner panel 30 is overlapped and welded to the rear flange portion 28 of the pillar outer panel 20 via the rear flange portion 48 of the pillar reinforcement 40. As a result, the rear pillar 14 has a substantially rectangular closed sectional shape as viewed in planar section.

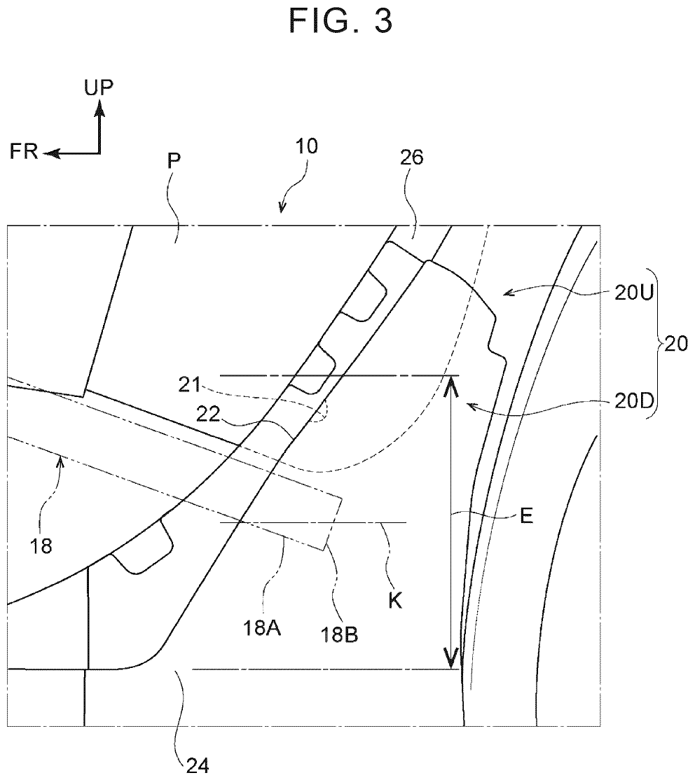

As shown in FIGS. 1 and 3, on the front side of the rear pillar 14, a rear side door 16 as an example of a side door is arranged so as to be openable and closable with a front end side as a hinge portion side. Inside the rear side door 16, a door impact beam 18 is provided as a door frame member extending in a substantially front-rear direction (in particular, slightly tilted obliquely downward from the front side toward the rear side).

The door impact beam 18 is formed in a cylindrical shape having a predetermined outer diameter and an inner diameter, and the rear end 18A overlaps the pillar outer panel 20 (panel lower portion 20D) as viewed from a side in the vehicle width direction (hereinafter, simply referred to as “as viewed from the side”). As shown in FIGS. 1 to 3, a recessed portion 21 recessed toward the rear side is formed as a bead portion extending in the vehicle width direction in a predetermined region E (see FIG. 3) as viewed from the side. The predetermined region E includes a portion of the front wall 22 of the pillar outer panel 20 at the same height as the rear end 18A of the door impact beam 18.

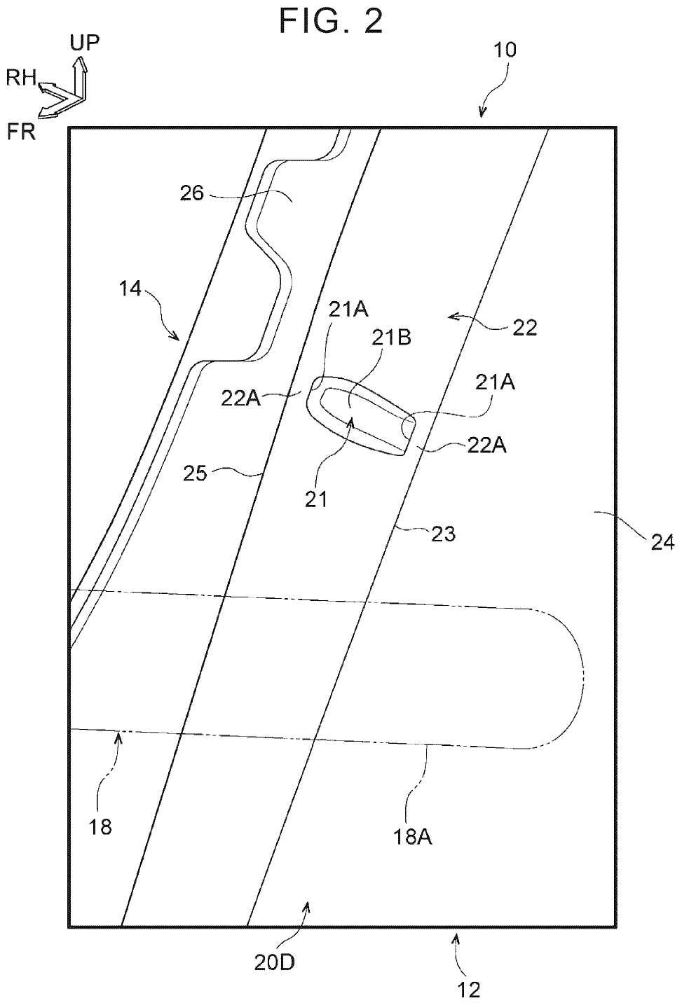

Specifically, as shown in FIG. 2, the recessed portion 21 is formed in a substantially elliptical shape having a vehicle width direction as a longitudinal direction as viewed from the front, and is formed except for both ends 22A of the front wall 22 in the vehicle width direction. In other words, both ends 21A in the vehicle width direction of the recessed portion 21 are formed so as not to reach the ridge line portion 23 serving as a boundary portion between the front wall 22 and the outer wall 24 and the ridge line portion 25 serving as a boundary portion between the front wall 22 and the front flange portion 26, respectively.

As shown in FIG. 3, the predetermined region E in which the recessed portion 21 is formed is a region in the front wall 22 of the pillar outer panel 20 that is within 100 mm upward and downward from the reference line K in the rear end 18A of the door impact beam 18, as viewed from the side. The “reference line K” as used herein refers to a horizontal imaginary straight line passing through the center of the inner diameter of the door impact beam 18 on the same plane as the rear end surface 18B of the door impact beam 18, as viewed from the side.

Further, as shown in FIG. 4, the recessed portion 21 is formed such that the bottom 21B thereof is obliquely tilted as viewed in planar section so that the depth of the vehicle width direction inner side is deeper than the depth of the vehicle width direction outer side. As a result, the pillar outer panel 20 (panel lower portion 20D) is easily demolded during press molding of the pillar outer panel 20 (panel lower portion 20D).

Next, the operation of the vehicle side structure 10 according to the present embodiment configured as described above will be described.

As described above, a cylindrical door impact beam 18 extending in the substantially front-rear direction is provided inside the rear side door 16. The rear end 18A of the door impact beam 18 overlaps the pillar outer panel 20 (panel lower portion 20D) constituting the rear pillar 14, as viewed from the side.

A recessed portion 21 extending in the vehicle width direction is formed in the predetermined region E including a portion of the front wall 22 of the pillar outer panel 20 at the same height position as the rear end 18A of the door impact beam 18, as viewed from the side. Therefore, stiffness of the front wall 22 of the pillar outer panel 20 against an inward load in the vehicle width direction can be improved as compared with a case where the recessed portion 21 extending in the vehicle width direction is not formed in the front wall 22 of the pillar outer panel 20.

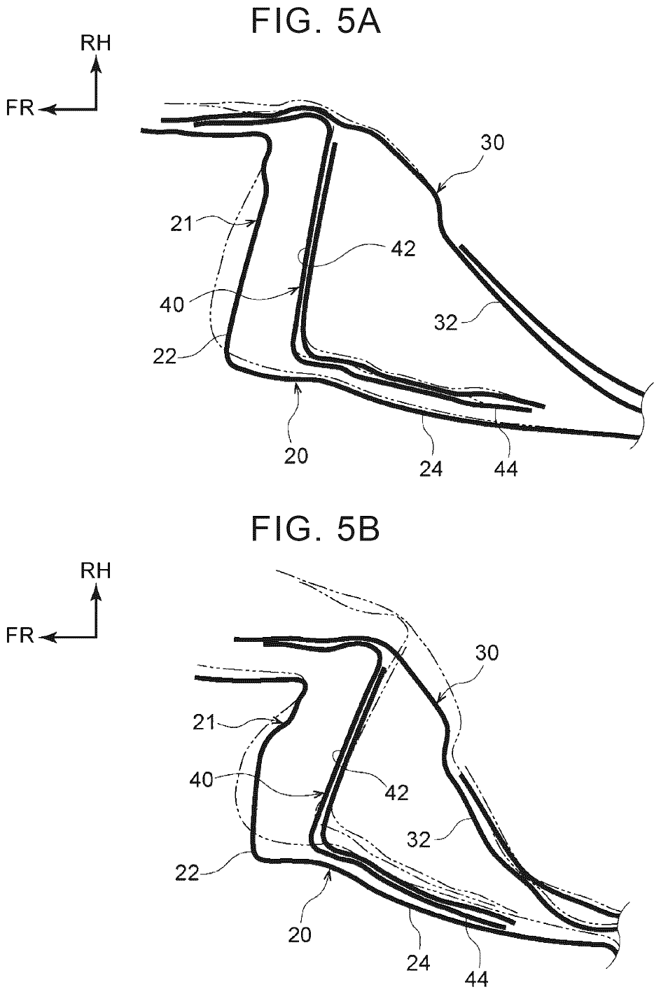

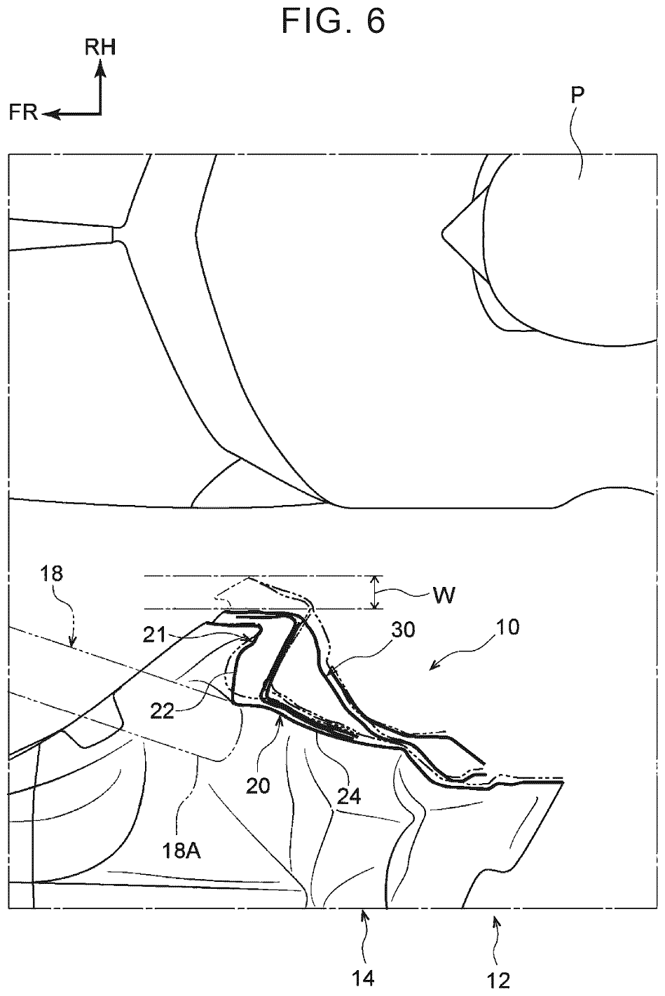

In the event of a side-impact collision of the vehicle 12, an inward load in the vehicle width direction may be applied from the rear end 18A of the door impact beam 18 to the rear pillar 14 (pillar outer panel 20). Even in this case, as shown in FIGS. 5A, 5B, and 6, deformation of the rear pillar 14 due to the load can be suppressed as compared with a case where the recessed portion 21 is not formed (shown by imaginary lines in FIGS. 5A, 5B, and 6). Specifically, inward buckling deformation in the vehicle width direction of the front wall 22 of the pillar outer panel 20 can be reduced by about 10 mm (shown by the width W in FIG. 6). Therefore, it is possible to reduce the injury value experienced by the occupant P.

The recessed portion 21 is formed except for both ends 22A in the vehicle width direction of the front wall 22 of the pillar outer panel 20. In other words, both ends 21A in the vehicle width direction of the recessed portion 21 do not reach the ridge line portion 23 serving as a boundary portion between the front wall 22 and the outer wall 24 and the ridge line portion 25 serving as a boundary portion between the front wall 22 and the front flange portion 26 (see FIG. 2).

Therefore, the stiffness of the pillar outer panel 20 can be further improved as compared with a case where the recessed portion 21 includes both ends 22A in the vehicle width direction of the front wall 22 of the pillar outer panel 20. In other words, the stiffness of the pillar outer panel 20 can be further improved as compared with cases where both ends 21A in the vehicle width direction of the recessed portion 21 reach the ridge line portion 23 and the ridge line portion 25, respectively. Specifically, stiffness of the front wall 22 of the pillar outer panel 20 against an inward load in the vehicle width direction can be further improved. Accordingly, even when an inward load in the vehicle width direction is applied from the rear end 18A of the door impact beam 18 to the rear pillar 14 in the event of a side-impact collision of the vehicle 12, deformation of the rear pillar 14 due to the load can be suppressed more effectively.

The region E in which the recessed portion 21 is formed is, in other words, a predetermined region E including a portion of the front wall 22 of the pillar outer panel 20 at the same height position as the rear end 18A of the door impact beam 18. The predetermined region E is a region within 100 mm upward and downward from the reference line K in the rear end 18A of the door impact beam 18.

Therefore, the stiffness of the pillar outer panel 20 can be more effectively secured as compared to a case where, for example, the predetermined region E is a region within 200 mm upward from the reference line K in the rear end 18A of the door impact beam 18. Specifically, it is possible to more effectively ensure stiffness of the front wall 22 of the pillar outer panel 20 against an inward load in the vehicle width direction that is applied from the rear end 18A of the door impact beam 18. Accordingly, even when an inward load in the vehicle width direction is applied from the rear end 18A of the door impact beam 18 to the rear pillar 14 in the event of a side-impact collision of the vehicle 12, deformation of the rear pillar 14 due to the load can be suppressed more effectively.

Further, in the vehicle side structure 10 according to the present embodiment, the bead portion formed on the front wall 22 of the pillar outer panel 20 is a recessed portion 21 recessed toward the rear side. Therefore, compared with the case where the bead portion is, for example, a convex portion protruding toward the front side, there is no effect on the opening and closing of the rear side door 16, and there is an advantage that the shape of the rear side door 16 need not be changed in design.

Although the vehicle side structure 10 according to the present embodiment has been described with reference to the drawings, the vehicle side structure 10 according to the present embodiment is not limited to the illustrated vehicle side structure, and can be appropriately changed in design without departing from the gist of the present disclosure. For example, a plurality of recessed portions 21 as bead portions may be formed in the region E at predetermined intervals in the up-down direction.

The rear pillar 14 is not limited to the above-described configuration. For example, a reinforcing member as a pillar outer member having a configuration such as a panel lower portion 20D may be provided from the outside at a lower portion of the pillar outer panel 20 extending in the up-down direction. The reinforcing member may have a configuration in which the recessed portion 21 is formed.

What is claimed is:

1. A vehicle side structure comprising:
a pillar outer member that constitutes a pillar, the pillar outer member having a substantially L-shape made by a front wall and an outer wall as viewed in section in a vehicle up-down direction; and
a door frame member provided inside a side door so as to extend in a vehicle front-rear direction, a rear end of the door frame member overlapping the pillar outer member as viewed from a side in a vehicle width direction,
wherein a bead portion extending in the vehicle width direction is provided in a predetermined region including a portion of the front wall of the pillar outer member, the portion of the front wall being a portion located at the same height position as the rear end of the door frame member as viewed from the side in the vehicle width direction.

2. The vehicle side structure according to claim 1, wherein the bead portion is provided in the front wall except for both ends in the vehicle width direction of the front wall.

3. The vehicle side structure according to claim 1, wherein the predetermined region is a region within 100 millimeters upward and downward in the vehicle up-down direction from the rear end of the door frame member.

4. The vehicle side structure according to claim 1, wherein the bead portion is a recessed portion recessed toward a rear of a vehicle.
